(19) United States
(12) Patent Application Publication
(10) Pub. No.: US 2022/0048286 A1
(43) Pub. Date: Feb. 17, 2022

(54) PRINTING PATTERNS VIA DIE CUTTING

(71) Applicant: 3M INNOVATIVE PROPERTIES COMPANY, St. Paul, MN (US)

(72) Inventors: Thomas J. Metzler, St. Paul, MN (US); Kara A. Meyers, Oakdale, MN (US); Saagar A. Shah, Minneapolis, MN (US); Mikhail L. Pekurovsky, Bloomington, MN (US); Matthew S. Stay, Bloomington, MN (US); Shawn C. Dodds, St. Paul, MN (US); Kevin T. Reddy, Minneapolis, MN (US); John T. Strand, Stillwater, MN (US); Daniel J. Theis, Mahtomedi, MN (US); Jeremy O. Swanson, Woodbury, MN (US); Daniel M. Lentz, Cottage Grove, MN (US)

(21) Appl. No.: 17/250,876

(22) PCT Filed: Oct. 16, 2019
(86) PCT No.: PCT/IB2019/058835

§ 371 Date: Mar. 18, 2021

Related U.S. Application Data
(60) Provisional application No. 62/746,674, filed on Oct. 17, 2018.

(51) Int. Cl. B41F 31/26; B41F 19/02

(52) U.S. Cl. CPC B41F 31/26; B41F 19/02

(57) ABSTRACT

Methods, apparatuses and systems for printing an ink pattern on a moving web via die cutting are provided. A die roll including an inked pattern of die blades contacts a substrate to cut or cleave the substrate surface. While the die blades withdraw from the substrate, at least some of the ink transfers from the die blades to the cut substrate to form an ink pattern.

### TECHNICAL FIELD

The present disclosure relates to methods and apparatuses for printing an ink pattern on a substrate.

### BACKGROUND

Patterned cutting mechanisms such as rotary dies have been widely used. A web can be fed between die cutting rollers that cut into the web surface to make patterns thereon.

### SUMMARY

Methods and apparatuses for printing patterns on a moving web via die cutting are provided. Briefly, in one aspect, the present disclosure describes a method of printing, including inking one or more die blades on a surface of a die roll by providing an ink material to the die blades; contacting the die blades to a substrate to cleave a surface of the substrate and make one or more notches thereon; and while detaching the die blades from the substrate, transferring at least some of the ink material from the die blades of the die roll to the respective notches on the substrate to form an ink pattern thereon.

In another aspect, the present disclosure describes a printing system including a die roll having a pattern of die blades on a surface thereof configured to receive an ink material; an impression roll positioned adjacent to the die roll to form a nip; and a substrate provided into the nip. The die blades cleave a surface of the substrate to make one or more notches thereon, and at least some of the ink material is transferred from the die blades to the respective notches on the substrate to form an ink pattern thereon while the substrate exits the nip. The ink pattern corresponds to the pattern of die blades.

Various unexpected results and advantages are obtained in exemplary embodiments of the disclosure. One such advantage of exemplary embodiments of the present disclosure is that printing an ink pattern on a substrate surface is achieved when cleaving the substrate surface in a die cutting process. That is, the processes of die-cutting and ink-printing are accomplished substantially at the same time. At least some of the ink can be retained in notches created by the cleaving, which can provide a more robust printing pattern serving as a separation barrier on the substrate surface. Furthermore, a precise registration between a cutting pattern (e.g., notches) and a printing pattern (e.g., ink retained in or adjacent to the notches) can be achieved since the processes of die-cutting and ink-printing are accomplished substantially simultaneously.

Various aspects and advantages of exemplary embodiments of the disclosure have been summarized. The above Summary is not intended to describe each illustrated embodiment or every implementation of the present certain exemplary embodiments of the present disclosure. The Drawings and the Detailed Description that follow more particularly exemplify certain preferred embodiments using the principles disclosed herein.

### BRIEF DESCRIPTION OF THE DRAWINGS

The disclosure may be more completely understood in consideration of the following detailed description of various embodiments of the disclosure in connection with the accompanying figures, in which:

FIG. 1 is a schematic diagram of a printing system, according to one embodiment of the present disclosure.

FIG. 2A is an enlarged portion view of the printing system of FIG. 1 where ink is transferred from an inking roll to a die roll.

FIG. 2B is an enlarged portion view of the printing system of FIG. 1 where ink is disposed on die blades of the die roll.

FIG. 3A is an enlarged portion view of the printing system of FIG. 1 where the die blades of the die roll cleave a substrate surface, according to one embodiment.

FIG. 3B is an enlarged portion view of the printing system of FIG. 1 where the die blades of the die roll cleave a substrate surface, according to another embodiment.

FIG. 3C is an enlarged portion view of the printing system of FIG. 1 where the die blades of the die roll cleave a substrate surface, according to another embodiment.

FIG. 4 is an enlarged portion view of the printing system of FIG. 3C where ink is transferred from the die blades to notches on the substrate.

FIG. 5A is a plan view of a pattern of die blades of a die roll, according to one embodiment of the present disclosure.

FIG. 5B is a plan view of a printing pattern on a substrate corresponding to the pattern of die blades of the die roll in FIG. 5A.

FIG. 5C is an enlarged portion cross-sectional view of the printing pattern of FIG. 5B.

FIG. 6 illustrates a flow diagram of a method of printing an ink pattern via die cutting, according to one embodiment.

In the drawings, like reference numerals indicate like elements. While the above-identified drawing, which may not be drawn to scale, sets forth various embodiments of the present disclosure, other embodiments are also contemplated, as noted in the Detailed Description. In all cases, this disclosure describes the presently disclosed disclosure by way of representation of exemplary embodiments and not by express limitations. It should be understood that numerous other modifications and embodiments can be devised by those skilled in the art, which fall within the scope and spirit of this disclosure.

### DETAILED DESCRIPTION

For the following Glossary of defined terms, these definitions shall be applied for the entire application, unless a different definition is provided in the claims or elsewhere in the specification.

### Glossary

Certain terms are used throughout the description and the claims that, while for the most part are well known, may require some explanation. It should be understood that:

The term “cutting die” refers to a die plate or rotary tool having a pattern machined into its face as a cutting feature. The pattern may represent the desired artwork to be formed on a substrate when the cutting feature engages with the substrate surface.

The term “cut,” “cutting,” “cleave,” or “cleaving” as used in this specification includes, for example, cut through, score or kiss cut and controlled depth cut segments of a web that is typically a part of or used to make an article. Cut through means that at least one of the layer(s) of a web or an article have been completely cut. Score or kiss cut means that the cut extends to a specific layer or depth of a web or article without completely penetrating that specific layer or the web. A process of cutting a layer can form a new surface (e.g., side surfaces of a notch created by cutting) that is exposed from within the bulk of that layer, and the new surface may be different from the original surface of that layer. The use of bearer bars can assist in setting the depth of the kiss cut. In some embodiments, a web may include a functional layer and a liner. The use of bearer bars may entail cutting through the functional layer to the liner, or cutting the functional layer to a specific predetermined depth.

By using terms of orientation such as “atop”, “on”, “over,” “covering”, “uppermost”, “underlying” and the like for the location of various elements in the disclosed coated articles, we refer to the relative position of an element with respect to a horizontally-disposed, upwardly-facing substrate. However, unless otherwise indicated, it is not intended that the substrate or articles should have any particular orientation in space during or after manufacture.

The terms “about” or “approximately” with reference to a numerical value or a shape means+/−five percent of the numerical value or property or characteristic, but expressly includes the exact numerical value. For example, a viscosity of “about” 1 Pa-sec refers to a viscosity from 0.95 to 1.05 Pa-sec, but also expressly includes a viscosity of exactly 1 Pa-sec. Similarly, a perimeter that is “substantially square” is intended to describe a geometric shape having four lateral edges in which each lateral edge has a length which is from 95% to 105% of the length of any other lateral edge, but which also includes a geometric shape in which each lateral edge has exactly the same length.

The term “substantially” with reference to a property or characteristic means that the property or characteristic is exhibited to a greater extent than the opposite of that property or characteristic is exhibited. For example, a substrate that is “substantially” transparent refers to a substrate that transmits more radiation (e.g. visible light) than it fails to transmit (e.g. absorbs and reflects). Thus, a substrate that transmits more than 50% of the visible light incident upon its surface is substantially transparent, but a substrate that transmits 50% or less of the visible light incident upon its surface is not substantially transparent.

As used in this specification and the appended embodiments, the singular forms “a”, “an”, and “the” include plural referents unless the content clearly dictates otherwise. Thus, for example, reference to fine fibers containing “a compound” includes a mixture of two or more compounds. As used in this specification and the appended embodiments, the term “or” is generally employed in its sense including “and/or” unless the content clearly dictates otherwise.

As used in this specification, the recitation of numerical ranges by endpoints includes all numbers subsumed within that range (e.g. 1 to 5 includes 1, 1.5, 2, 2.75, 3, 3.8, 4, and 5).

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present disclosure. At the very least, and not as an attempt to limit the application of the doctrine of equivalents to the scope of the claimed embodiments, each numerical parameter should at least be construed in light of the number of reported significant digits and by applying ordinary rounding techniques.

Various exemplary embodiments of the disclosure will now be described with particular reference to the Drawings. Exemplary embodiments of the present disclosure may take on various modifications and alterations without departing from the spirit and scope of the disclosure. Accordingly, it is to be understood that the embodiments of the present disclosure are not to be limited to the following described exemplary embodiments, but are to be controlled by the limitations set forth in the claims and any equivalents thereof.

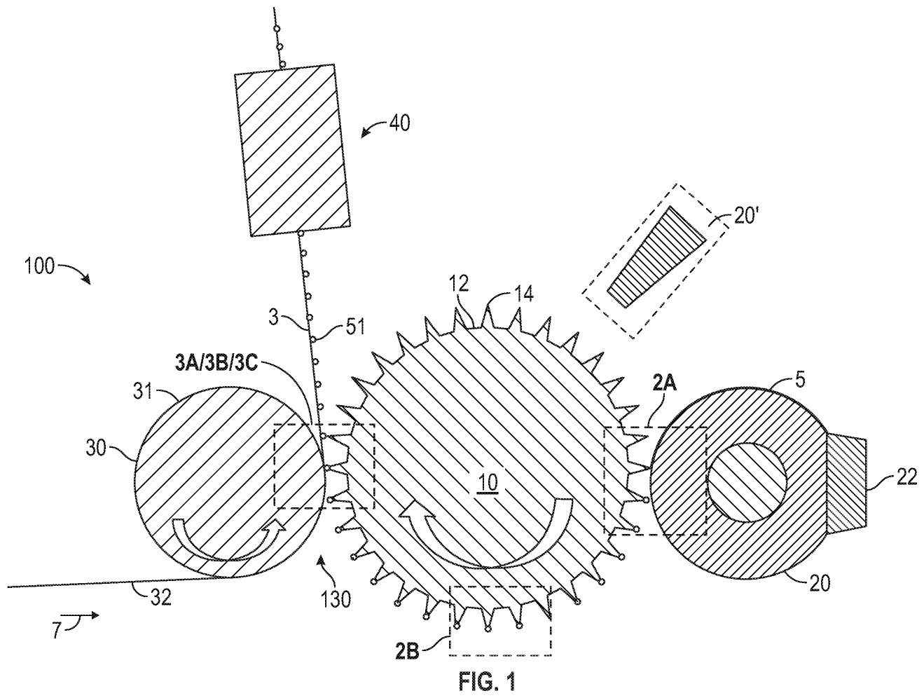

FIG. 1 is a schematic diagram of a printing system 100 to print a pattern on a web in a roll-to-roll process, according to one embodiment of the present disclosure. The printing system 100 includes a die roll 10 having a pattern of die blades 14 on a surface 12 thereof. In some embodiments, the die blades 14 can be formed on a cutting die and the cutting die can be releasably attached to the mounting surface 12 of the die roll 10. In some embodiments, the die roll 10 may be formed by two or more rolls (e.g., a primary roll, and a secondary roll) that are coaxially arranged side by side. A first pattern of die blades can be provided on one of the rolls (e.g., the primary roll), and a second pattern of die blades can be provided on another roll (e.g., the secondary roll).

The printing system 100 further includes an inking roll 20 which is configured to transfer an ink material 5 from the surface of the inking roll 20 to the die blades 14 of the die roll 10. The die roll 10 and the inking roll 20 are rotatably mounted adjacent to each other with the respective axes parallel to each other. The ink material 5 is coated onto the inking roll 20 by an applicator 22. In some embodiments, the ink material 5 may be applied to the surface of the inking roll 20 by the applicator 22 that sprays, brushes, or dispenses the ink material 5 onto a portion of the inking roll 20 while the inking roll 20 axially rotates. In some embodiments, a portion of the inking roll 20 may be submerged in the ink material 5 held in a basin or other reservoir of the applicator 22. It is to be understood that any suitable applicator can be used to apply an ink material with a desired width on the surface of the inking roll 20. Exemplary applicators can be commercially available from Retroflex, Inc. (Wrightstown, Wis.) under a trade designation of Reverse Angle Doctor Blade Systems (RADBS). The ink material 5 can include any suitable ink compositions. Typical ink materials can include, for example, water- or solvent-based flexographic printing ink compositions, 100% solids, UV curable inks or adhesives, etc.

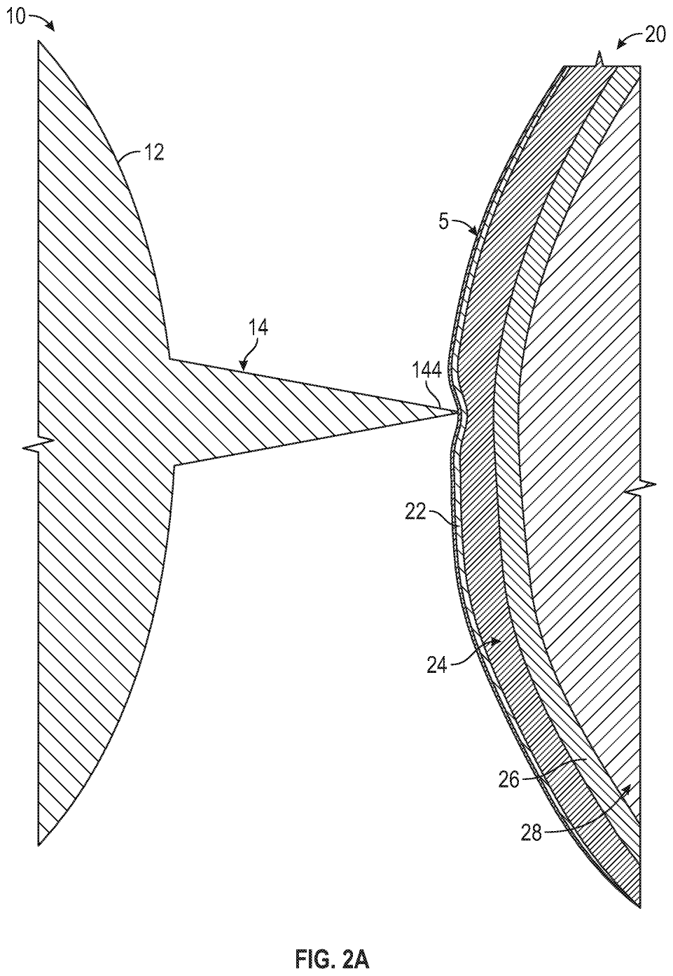

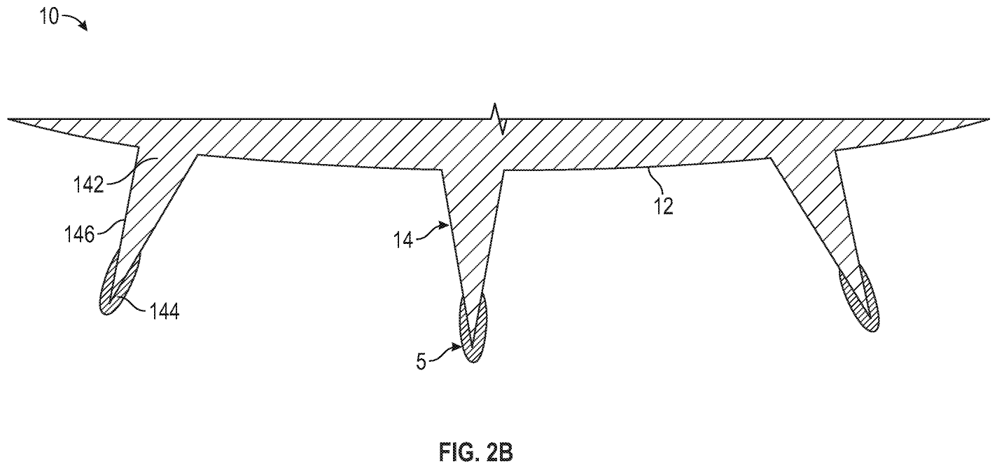

FIG. 2A is an enlarged portion view of the printing system of FIG. 1 where the ink material 5 is transferred from the inking roll 20 to the die roll 10. In the depicted embodiment of FIG. 2A, the inking roll 20 has a deformable surface and a layer of ink material 5 is coated on the surface of the inking roll 20. The inking roll 20 includes a thin shell or skin layer 22 and a resilient layer 24 mounted, via a fiberglass 26, on a rigid central core 28. The resilient layer 24 conveniently has a hardness that deforms to a certain extent, and may not allow the thin shell 22 to deform beyond its elastic limit by the pressure from the die blades 14. To achieve this criterion, the resilient layer 24 may conveniently include elastic materials such as, for example, a rubber with a hardness within an appropriate range, for example, no less than 20, 40, 60, 80, or 100 Shore A, and no greater than 100, 80, 60, 40, or 20 Shore D. In some embodiments, the resilient layer 24 may be compressible and capable of preventing slip between the thin shell 22 and the resilient layer 24. In some embodiments, the compressible resilient layer 24 may be made of a foam. In some embodiments, the compressible resilient layer 24 may include a patterned elastomer that allows the resilient layer 24 to be effectively compressible. The patterned elastomer may have patterned structures (e.g., engraved surface structures) located on the outer surface of the resilient layer 24 that contacts to the thin shell 22. The patterned structure may be formed by imparting onto the surface of the rubber with any suitable techniques including, for example, engraving, ablating, molding, etc.

The metal shell 22 is much thinner as compared to the diameter of the inking roller 20. In some embodiments, the ratio between the thickness of the thin shell 22 and the diameter of the inking roll 20 may be, for example, no greater than 1:20, no greater than 1:50, no greater than 1:80, no greater than 1:100, no greater than 1:200, or no greater than 1:500. A useful range of the metal shell thickness may be, for example, between about 0.1 mm and about 0.6 mm. In some embodiments, the metal shell may include fine dimples or cells on a surface thereof to receive the ink material 5. In some embodiments, a doctor blade can be used to blade ink into the cells and remove excess ink from the surface of the metal shell, leaving just the measured amount of ink in the cells. In some embodiments, the thin shell 22 can be made of, for example, a metal such as nickel, an elastomer, a ceramic or polymeric material, a combination thereof, etc. It is to be understood that the inking roll 20 can have any other configurations to provide a deformable surface.

Referring again to FIG. 2A, the die roll 10 and the inking roll 20 are positioned such that the die blades 14 can be rotatably impressed into the surface of the inking roll 20. The thin shell 22 can deflect in unison with the resilient layer 24 such that the thin shell 22 is elastically deformed when in contact with the die blade 14. The ink material 5 can be transferred from the surface of the metal shell 22 to the die blade 14 upon the contact. As shown in FIG. 2B, the die blades 14 each include a base 142 attached to the surface 12 of the die roll 10. A cutting edge 144 can be formed with various shapes where sloped side surfaces 146 meet. The ink material 5 transferred from the inking roll 20 is disposed on the cutting edges 144 and adjacent portions of side surfaces 146 of the die blades 14. In some embodiments, the cutting edges 144 and the side surfaces 146 can be surface-treated to control the amount of ink material 5 that can be transferred to the die blades 14. For example, a hydrophilic coating can be provided on the die blades 14 to enhance the ink wet-out on the die blades.

In some embodiments, the inking roll 20 may be a rigid roll such as, for example, an anilox roll, a gravure roll, etc. A typical anilox roll may include a hard cylinder, usually constructed of a steel or aluminum core which is coated by an industrial ceramic. The surface of the roll may contain fine dimples, known as cells, to receive an ink material. Suitable ink metering systems can be applied. For example, a self-contained system such as a chambered doctor blade system can be used, which includes a manifold to deliver ink to the anilox roll.

It is to be understood that the die blades of the die roll can be inked by various methods or processes other than by an inking roll. In some embodiments, one or more ink materials can be provided to the die blades by inkjet printing. As shown in FIG. 1, an optional inkjet printing apparatus 20′ is provided to propel droplets of ink onto the die blades 14. In some embodiments, the inkjet printing apparatus 20′ can be programmed to print various patterns of ink onto the die blades, which can then be transferred to a substrate. The inkjet printing apparatus 20′ can be used independently, optionally, or cooperatively with the inking roll 20.

The die roll having the inked die blades 14 can rotate to cleave a substrate surface such that when the engaged die blade withdraws from the substrate surface, at least some of the ink is retained on the substrate surface to form an ink pattern thereon. Referring again to FIG. 1, the die roll 10 having the die blades 14 rotates into cutting engagement with an impression roll 30 positioned adjacent to the die roll 10. The die roll 10 and the impression roll 30 are rotatably mounted adjacent to each other with the respective axes parallel to each other along a cross-web or lateral direction to form a web path to covey a web 3. A nip 130 is formed between the die roll 10 and the impression roll 30, and the web 3 is provided into the nip 130.

In some embodiments, the web 3 may include a flexible or stretchable material, such as a flexible polymeric web. The web 3 is conveyed along its longitudinal direction 7 (i.e., a machine direction, or a down-web direction) into the nip 130. When the web 3 is disposed between the surface 12 of the die roll 10 and the contact surface 31 of the impression roll 30, the die blades 14 of the die roll 10 cleave the web surface 32 on the side of the die roll 10. While the engaged die blades 14 withdraw from the web 3, at least some of the ink material 5 transfers from the die blades 14 of the die roll 10 to the web surface 32 to form an ink pattern 51 thereon. The ink pattern 51 is then cured by a curing mechanism 40. In some embodiments, the ink material 5 can include a photo initiator, and the ink pattern 51 can be cured by radiation such as, for example, a UV light. In some embodiments, the ink material 5 can include a thermal initiator, and the ink pattern 51 can be cured by heat. In some embodiments, the ink material 5 can be dried by removing solvent or water therefrom.

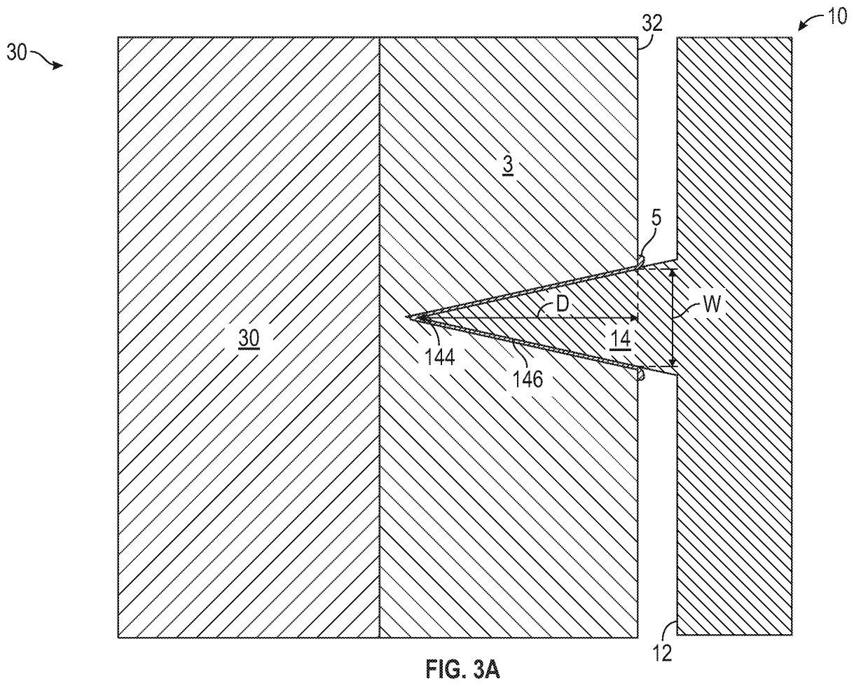

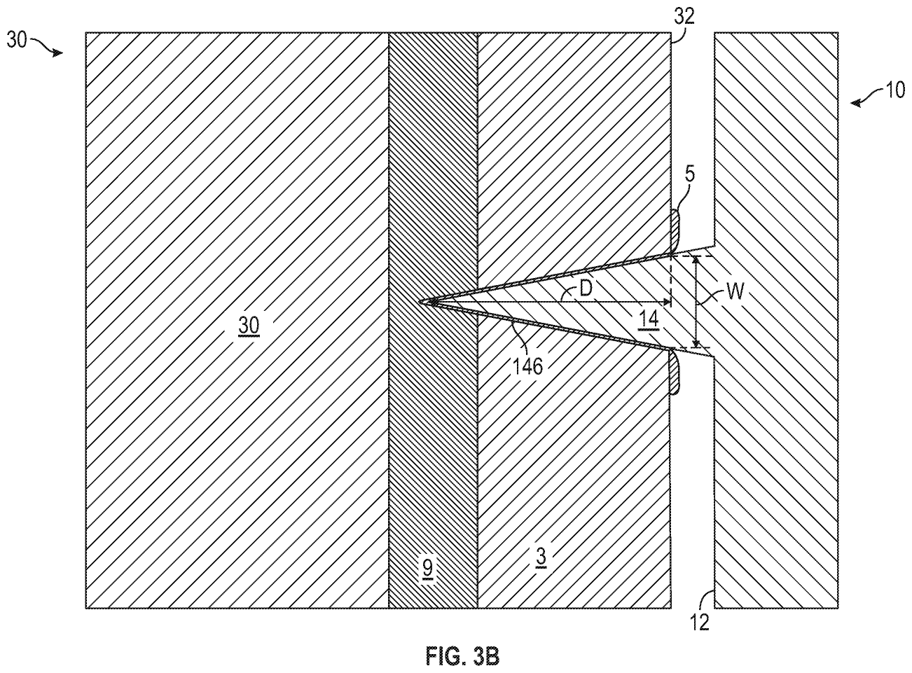

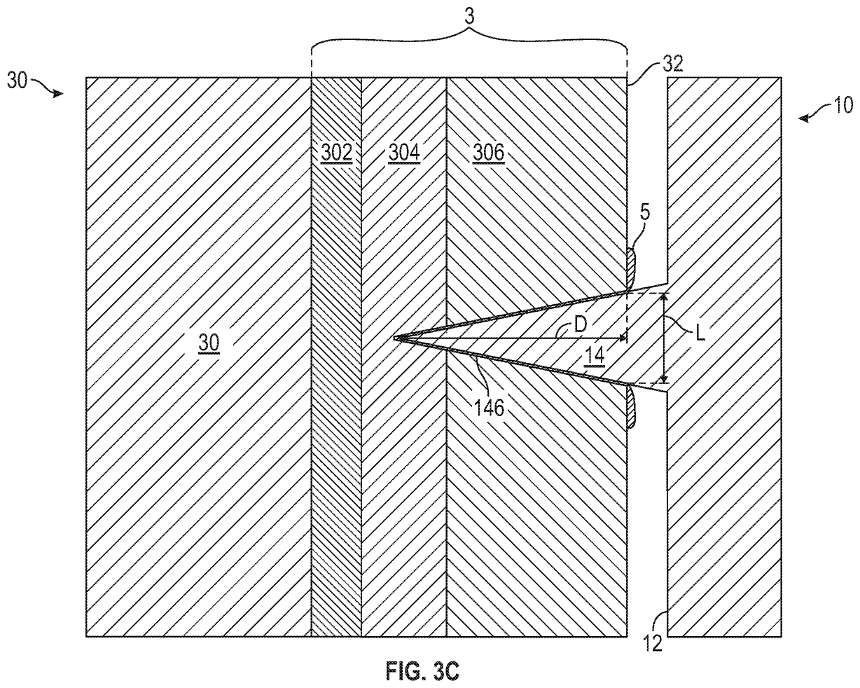

FIG. 3A is an enlarged portion view of the printing system of FIG. 1 where the die blade 14 of the die roll 10 cleaves the web surface 32, according to one embodiment. The die blade 14 cuts into the web surface 32 and makes a notch by cracking the web surface 32. Such a process of cleaving or cutting creates a new surface (e.g., one or more side surfaces of the notch created by the cleaving or cutting) that is exposed from within the bulk of the web 3. The process of cleaving or cutting described herein is different from a process of embossing or indenting. In the embossing or indenting of a web, the web surface is deformed or stretched (e.g., conformal to the shape of an embossing or indenting tool) without creating a new surface that is exposed from within the bulk of the web.

A notch created by cutting or cleaving can have a depth D and a width W. In some embodiments, the width W can be in a range, for example, from about 10 micrometers to about 2 mm. In some embodiments, the depth D can be in in the range, for example, from about 10 micrometers to about 2 mm. It is to be understood that any desired shapes and dimensions of a notch can be created by using various die blades and/or controlling the cutting depth D. For example, the use of a bearer bar can assist in setting the depth D of the kiss cut. Upon the cutting, the ink material 5 originally disposed on or adjacent to the cutting edge 144 of the die blade can spread along the side surfaces 146 and be pushed onto the web surface 32 adjacent to the die blade 14.

In the depicted embodiment of FIG. 3A, the die blade 14 cuts partially through the bulk of the web 3. In the depicted embodiment of FIG. 3B, the die blade 14 cuts completely through the web 3 and partially into a second layer 9 disposed on the web 3 on the side of the impression roll 30. In the depicted embodiment of FIG. 3C, the web 3 has a multilayer structure including a polymer layer 302, an adhesive layer 304, and a metal layer 306 disposed on the polymer layer 302 via the adhesive layer 304. The die blade 14 cleaves completely through the metal layer 306 and partially into the adhesive layer 304 which is sandwiched between the polymer layer 302 and the metal layer 306. It is to be understood that the web 3 can have various multi-layer structures for desired applications.

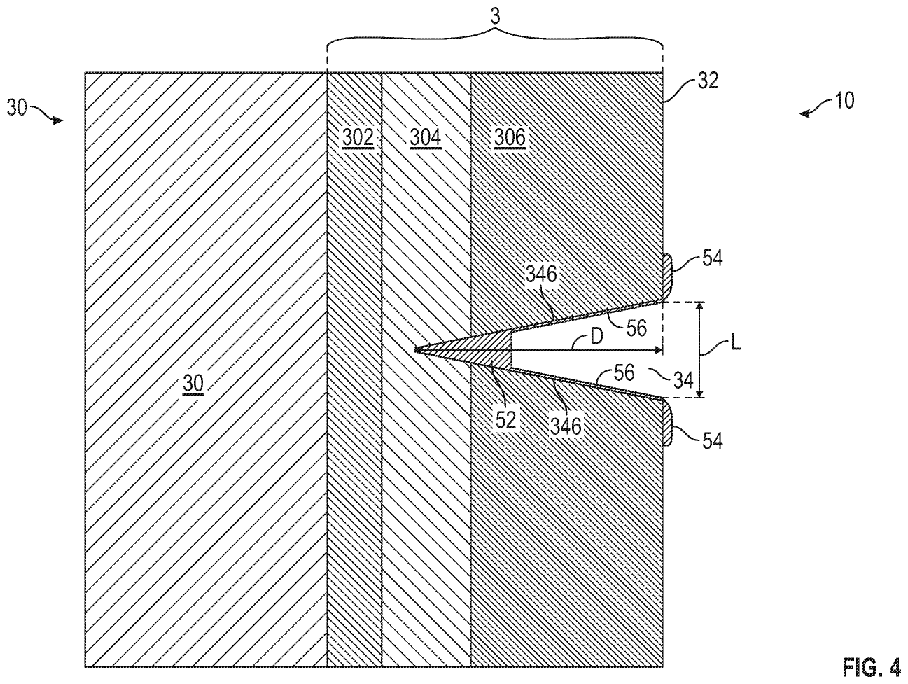

Referring again to FIG. 1, when the die roll 10 rotates and the web 3 exits the nip 130, the die blade 14 is detached or withdraws from the web 3. At least a portion of the ink material can be transferred from the die blade 14 to the web 3 while disengaging the die blade 14 from the web 3. FIG. 4 is an enlarged portion view of the article of FIG. 3C where at least some of the ink material has been transferred from the die blade 14 to the web 3.

In the depicted embodiment of FIG. 4, the notch 34 is formed via die cutting where the die blade 14 cuts into the web surface 32 to create one or more new surfaces 346 that are exposed from within the bulk of the web 3. The side surfaces 346 of the notch 34 are newly created by cutting or cleaving, which are different from a deformation surface created by embossing or indenting the web surface 32. While the die blade 14 withdraws from the web 3, the transferred ink material is retained on the web 3 in various ways: a first portion 52 of the ink material resides in a bottom portion of the notch 34; a second portion 54 of the ink material resides on the web surface 32 adjacent to an opening edge of the notch 34; and a layer of ink material 56 is disposed on the side surface 346 of the notch 34. In some embodiments, a majority of the transferred ink material can be retained in the notch 34. In other embodiments, a majority of the transferred ink material can be retained on the web surface 32 adjacent to the notch 34.

The distribution of the transferred ink material on the web 3 may depend on many factors including, for example, the surface energy of the web surface 32, the surface energy of the side surface 146 of the die blades 14, the surface energy of the side surface 346 of the notch 34, the surface energy of the ink material, etc. In some embodiments, the web surface 32 may have a relatively low surface energy. For example, the web 3 may be a substrate coated with a low energy material such as, for example, a siliconized PET. The cut by the die blade on the web creates new surfaces (e.g., the side surface 346 of the notch 34) that are exposed from within the bulk of the web 3. In some embodiments, the new surfaces 346 may have a relatively higher surface energy such that the ink material can relatively more easily wet out the side surface 346 of the notch 34 as compared to the substrate surface. In contrast, when the ink material is directly disposed on the substrate surface without die cutting, the ink material may bead up on the substrate surface rather than wet out, when the substrate surface has a lower surface energy than the ink material. Such a beading-up issue may present when embossing or indenting a web surface instead of cutting or cleaving the web surface.

In the depicted embodiment of FIG. 4, the notch 34 extends across the top layer 306 and partially into the underneath layer 304. The ink material fills the notch 34 with such an amount as sufficient to block contact between the opposite sides (e.g., the opposite side surfaces 346 of the notch 34) of the top layer 306. In some embodiments, the ink material may include electrically insulating material. The ink material can be solidified to form an electrically insulating pattern.

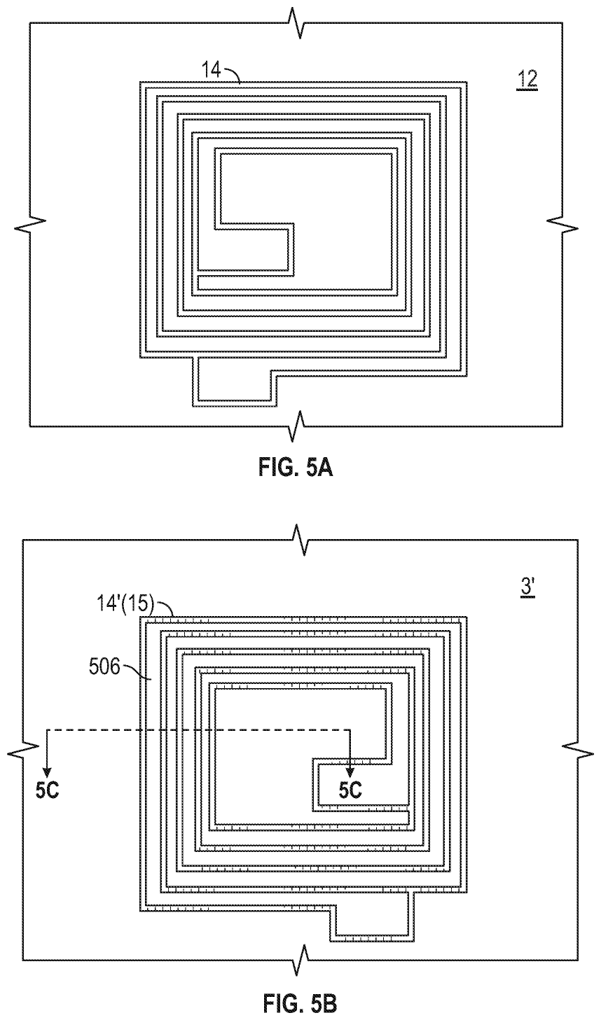

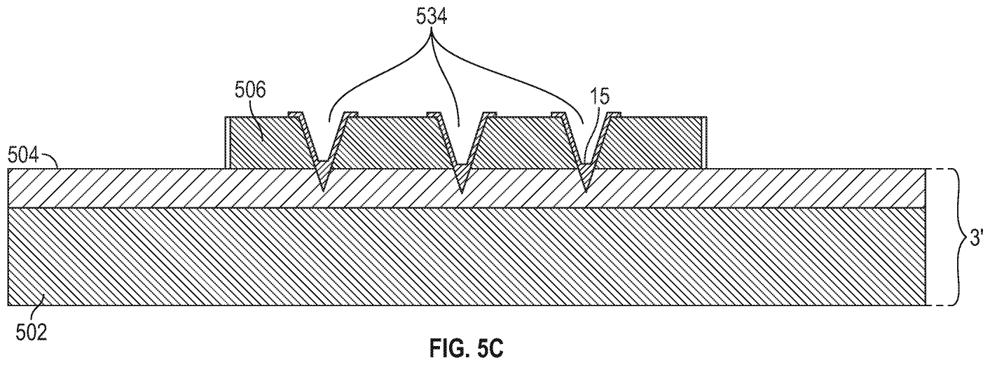

FIG. 5A is a plan view of a pattern of die blades 14 on a surface 12 of a die roll such as the die roll 10 of FIG. 1, according to one embodiment. FIG. 5B is a plan view of a printing pattern 14′ on a substrate 3′ corresponding to the pattern of die blades 14 of the die roll in FIG. 5A. FIG. 5C is an enlarged portion cross-sectional view of the printing pattern 14′ of FIG. 5B. A metal layer 506 is provided on a carrier substrate 502 via an adhesive 504. The pattern of die blades 14 of FIG. 5A are inked by providing an ink material to the die blades. The pattern of die blades 14 of FIG. 5A contacts to the metal layer 506 to completely cut through the metal layer 506 and partially into the adhesive 504 to make a pattern of notches 534 on the substrate 3′. When the die blades 14 withdraw from the substrate 3′, at least some of the ink material transfers from the die blades 14 to the respective notches 534 on the substrate 3′ to form the ink pattern 14′ thereon. The ink pattern 14′ can then be solidified, e.g., by the curing mechanism of FIG. 1, to form an electrically insulating pattern 15.

In the depicted embodiment of FIGS. 5A-C, the notches 534 create spacing between turns of metals on the metal layer 506 which form a spiral antenna on the web 3′. The electrically insulating pattern 15 is precisely registered with the notches 534, which as a whole can create insulative spacing between the turns of metals 506. The insulating material in the notches 534 can serve as a separation barrier to electrically insulate the adjacent metal turns 506, in particular when the web 3′ is under stretching, bending, or both. In the absence of the printed insulating pattern 15, the adjacent metal turns 506 may meet with each other to induce electrical shorting, in particular when the web 3′ is deformed. It is to be understood that the insulating pattern 15 can have any desired shapes and can be applied to any flexible circuits.

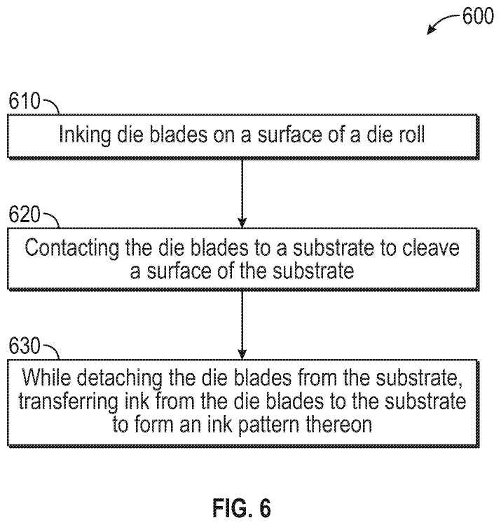

In the present disclosure, methods of printing an ink pattern on a substrate via die cutting are provided. FIG. 6 illustrates a flow diagram of a method 600 of printing an ink pattern via die cutting, according to one embodiment. The method 600 can be implemented by various apparatuses or systems shown in FIGS. 1 to 5C.

At 610, a die roll is provided with one or more die blades on a surface thereof. The die blades are inked by providing an ink material thereto. In some embodiments, inking the die blades further includes transferring the ink material from an inking roll to the die blades of the die roll. In some embodiments, the ink material can be coated onto a surface of the inking roll via an applicator. The inking roll can have a deformable surface. In some embodiments, inking the die blades further includes providing the ink material to the die blades by inkjet printing. The method 600 then proceeds to 620.

At 620, the inked die blades contact a substrate to cleave a surface of the substrate to make one or more notches thereon. Upton the contact, the die blades cleave the surface of the substrate to create one or more new surfaces that are exposed from within the bulk of the substrate, and the new surfaces serve as one or more sides of the notches. In some embodiments, contacting the die blades to the substrate further includes providing an impression roll positioned adjacent to the die roll to form a nip, and providing the substrate into the nip. The method 600 then proceeds to 630.

At 630, when the die blades withdraw from the substrate, at least some of the ink material is retained in the notches to form an ink pattern. In some embodiments, the ink material can be solidified to form a printing pattern on the substrate, sufficient to block contact between the sides of a notch and serve as a separation barrier for the substrate surface. In some embodiments, the ink material can be solidified by heat or radiation. As described herein, a precise registration between a cutting pattern (e.g., the notches 534 of FIG. 5C) and a printing pattern (e.g., the insulating pattern 15 of FIG. 5C) is achieved since the processes of die-cutting and ink-printing are accomplished substantially simultaneously. Such a high level of registration is challenging to achieve if cutting and printing are performed in separate steps.

In some embodiments, the substrate may have a multilayer structure including at least a first layer and a second layer. The die blades of the die roll can kiss-cut entirely through the first layer and into the second layer. The retained ink can have an amount sufficient to block contact between the sides of a notch through the first layer.

In some embodiments, the first layer of the substrate can be an electrically conductive layer (e.g., a metal foil) and the second layer can be a release liner adhered to the first layer. The ink material retained in notches can serve as an insulating barrier for the electrically conductive layer. The ink material can include any suitable ink compositions which can be dried, cured, or solidified to form an electrically insulating material. Exemplary ink materials can be commercially available from Nazdar Company (Shawnee, Kans.) under the trade designation of Nazdar 9400 Series UV Flexo Ink.

In some embodiments, the first layer of the substrate can be an optical film and the second layer can be a carrier layer. The optical film and the carrier layer can be assembled by an electrostatic attraction. The ink material retained in notches can serve as a separation barrier for the optical film. In some embodiments, the ink material can be opaque after solidification, which may resist the passage of oxygen and/or water vapor. Exemplary ink materials can be commercially available from Flint Group Company (Luxembourg) under the trade designation of Flint Group HMC 80080 UV ink.

In some embodiments, the first layer of the substrate can be a pressure sensitive adhesive (PSA), and the second layer can be a release liner adhered to the PSA. The ink material retained in notches can serve as a separation barrier for the PSA. In some embodiments, a cover layer can be provided to laminate onto the PSA on the side opposite to the release liner. The cover layer can be patterned. Exemplary ink materials can be commercially available from 3M Company (St. Paul, Minn.) under the trade designation of 3M Screen Printable Adhesive SP-7555 Transparent.

The operation of the present disclosure will be further described with regard to the following embodiments. These embodiments are offered to further illustrate the various specific and preferred embodiments and techniques. It should be understood, however, that many variations and modifications may be made while remaining within the scope of the present disclosure.

### Listing of Exemplary Embodiments

It is to be understood that any one of embodiments 1-17 and 18-30 can be combined.

Embodiment 1 is a method of printing, comprising:

inking one or more die blades on a surface of a die roll by providing an ink material to the die blades;

contacting the die blades to a substrate to cleave a surface of the substrate and make one or more notches thereon; and

while detaching the die blades from the substrate, transferring the ink material from the die blades of the die roll to the respective notches on the substrate to form an ink pattern thereon.

Embodiment 2 is the method according to embodiment 1, wherein inking the die blades further comprises transferring the ink material from an inking mechanism to the die blades of the die roll.
Embodiment 3 is the method according to embodiment 2, wherein the inking mechanism comprises an inking roll, and the ink material is applied onto a surface of the inking roll via an applicator.
Embodiment 4 is the method according to embodiment 3, wherein the inking roll has a deformable surface.
Embodiment 5 is the method according to any one of embodiments 2-4, wherein the inking mechanism comprises an inkjet printing apparatus.
Embodiment 6 is the method according to any one of embodiments 1-5, wherein contacting the die blades to the substrate further comprises providing an impression roll positioned adjacent to the die roll to form a nip, and providing the substrate into the nip.
Embodiment 7 is the method according to any one of embodiments 1-6, further comprising solidifying the ink material to form a printing pattern on the substrate.
Embodiment 8 is the method according to any one of embodiments 1-7, wherein the ink material is solidified by heat or radiation.
Embodiment 9 is the method according to any one of embodiments 1-8, wherein the notches each have a lateral dimension L of about 10 micrometers to about 2 mm, and a depth D in the range of about 10 micrometers to about 2 mm.
Embodiment 10 is the method according to any one of embodiments 1-9, further comprising solidifying the ink material to form an electrically insulating material.
Embodiment 11 is the method according to embodiment 10, wherein the substrate has an electrically conductive surface layer, and the electrically insulating material forms an insulating pattern across the electrically conductive surface layer.
Embodiment 12 is the method according to any one of embodiments 1-9, further comprising solidifying the ink material to form an optically opaque pattern.
Embodiment 13 is the method according to any one of embodiments 1-12, further comprising surface-treating the die blades to control the amount of ink material that is retained on the substrate.
Embodiment 14 is the method according to any one of embodiments 1-13, further comprising surface-treating the substrate to control the amount of ink material that is retained in the notches.
Embodiment 15 is the method according to any one of embodiments 1-14, wherein the die blades cleave the surface of the substrate to create one or more new surfaces that are exposed from within the bulk of the substrate, and the new surfaces serve as one or more sides of the notches.
Embodiment 16 is the method according to embodiment 15, wherein the new surfaces have a higher surface energy than that of the surface of the substrate.
Embodiment 17 is the method according to any one of embodiments 1-16, which is a roll-to-roll process.
Embodiment 18 is a printing system comprising:

a die roll having a pattern of die blades on a surface thereof configured to receive an ink material;

an impression roll positioned adjacent to the die roll to form a nip; and

a substrate provided into the nip,

wherein the die blades cleave a surface of the substrate to make one or more notches thereon, and at least some of the ink material is transferred from the die blades to the respective notches on the substrate to form an ink pattern thereon while the substrate exits the nip, the ink pattern corresponding to the pattern of die blades.

Embodiment 19 is the printing system according to embodiment 18, further comprising an inking mechanism configured to provide the ink material to the die lades of the die roll.
Embodiment 20 is the printing system according to embodiment 18 or 19, wherein the inking mechanism comprises an inking roll, and the ink material is transferred from the inking roll to the die blades of the die roll.
Embodiment 21 is the printing system according to embodiment 20, further comprises an applicator configured to coat the ink material onto a surface of the inking roll.
Embodiment 22 is the printing system according to embodiment 20 or 21, wherein the inking roll has a deformable surface.
Embodiment 23 is the printing system according to embodiment 22, wherein the inking roll includes a skin layer covering a deformable inner layer.
Embodiment 24 is the printing system according to any one of embodiments 18-23, wherein the inking mechanism comprises an inkjet printing apparatus.
Embodiment 25 is the printing system according to any one of embodiments 18-24, further comprising a curing mechanism.
Embodiment 26 is the printing system according to any one of embodiments 18-25, wherein the ink material is solidified to form an electrically insulating material.
Embodiment 27 is the printing system according to embodiment 26, wherein the substrate has an electrically conductive surface layer, and the electrically insulating material form an insulating pattern into the electrically conductive surface layer.
Embodiment 28 is the printing system according to any one of embodiments 18-25, wherein the ink material is solidified to form an opaque material.
Embodiment 29 is the printing system according to embodiment 28, wherein the substrate includes an optical film, and the opaque material form an opaque pattern into the optical film.
Embodiment 30 is the printing system according to embodiment 28 or 29, wherein the opaque material is capable of resisting the passage of oxygen and/or water vapor.

Reference throughout this specification to “one embodiment,” “certain embodiments,” “one or more embodiments” or “an embodiment,” whether or not including the term “exemplary” preceding the term “embodiment,” means that a particular feature, structure, material, or characteristic described in connection with the embodiment is included in at least one embodiment of the certain exemplary embodiments of the present disclosure. Thus, the appearances of the phrases such as “in one or more embodiments,” “in certain embodiments,” “in one embodiment” or “in an embodiment” in various places throughout this specification are not necessarily referring to the same embodiment of the certain exemplary embodiments of the present disclosure. Furthermore, the particular features, structures, materials, or characteristics may be combined in any suitable manner in one or more embodiments.

While the specification has described in detail certain exemplary embodiments, it will be appreciated that those skilled in the art, upon attaining an understanding of the foregoing, may readily conceive of alterations to, variations of, and equivalents to these embodiments. Accordingly, it should be understood that this disclosure is not to be unduly limited to the illustrative embodiments set forth hereinabove. In particular, as used herein, the recitation of numerical ranges by endpoints is intended to include all numbers subsumed within that range (e.g., 1 to 5 includes 1, 1.5, 2, 2.75, 3, 3.80, 4, and 5). In addition, all numbers used herein are assumed to be modified by the term “about.”

Furthermore, all publications and patents referenced herein are incorporated by reference in their entirety to the same extent as if each individual publication or patent was specifically and individually indicated to be incorporated by reference. Various exemplary embodiments have been described. These and other embodiments are within the scope of the following claims.

1. A method of printing, comprising:
inking one or more die blades on a surface of a die roll by providing an ink material to the die blades;
contacting the die blades to a substrate to cleave a surface of the substrate and make one or more notches thereon; and
while detaching the die blades from the substrate, transferring at least some of the ink material from the die blades of the die roll to the respective notches on the substrate to form an ink pattern thereon.

2. The method according to claim 1, wherein inking the die blades further comprises transferring the ink material from an inking mechanism to the die blades of the die roll.

3. The method according to claim 2, wherein the inking mechanism comprises an inking roll, and the ink material is applied onto a surface of the inking roll via an applicator.

4. The method according to claim 2, wherein the inking mechanism comprises an inkjet printing apparatus.

5. The method according to claim 1, wherein contacting the die blades to the substrate further comprises providing an impression roll positioned adjacent to the die roll to form a nip, and providing the substrate into the nip.

6. The method according to claim 1, further comprising solidifying the ink material to form a printing pattern on the substrate.

7. The method according to claim 1, further comprising solidifying the ink material to form an electrically insulating pattern.

8. The method according to claim 1, further comprising solidifying the ink material to form an optically opaque pattern.

9. The method according to claim 1, which is a roll-to-roll process.

10. A printing system comprising:
a die roll having a pattern of die blades on a surface thereof configured to receive an ink material;
an impression roll positioned adjacent to the die roll to form a nip; and
a substrate provided into the nip,
wherein the die blades cleave a surface of the substrate to make one or more notches thereon, and at least some of the ink material is transferred from the die blades to the respective notches on the substrate to form an ink pattern thereon while the substrate exits the nip, the ink pattern corresponding to the pattern of die blades.

11. The printing system according to claim 10, further comprising an inking mechanism configured to provide the ink material to the die lades of the die roll.

12. The printing system according to claim 11, wherein the inking mechanism comprises an inking roll, and the ink material is transferred from the inking roll to the die blades of the die roll.

13. The printing system according to claim 12, further comprises an applicator configured to coat the ink material onto a surface of the inking roll.

14. The printing system according to claim 11, wherein the inking mechanism comprises an inkjet printing apparatus.

15. The printing system according to claim 10, further comprising a curing mechanism.

16. The method according to claim 7, wherein the substrate has an electrically conductive surface layer, and the electrically insulating pattern runs across the electrically conductive surface layer.

17. The method according to claim 1, further comprising surface-treating the die blades to control the amount of ink material that is retained on the substrate.

18. The method according to claim 1, further comprising surface-treating the substrate to control the amount of ink material that is retained in the notches.

19. The method according to claim 1, wherein the die blades cleave the surface of the substrate to create one or more new surfaces that are exposed from within the bulk of the substrate, and the new surfaces serve as one or more sides of the notches.

20. The method according to embodiment 19, wherein the new surfaces have a higher surface energy than that of the surface of the substrate.
